(19) United States
(12) Patent Application Publication
(10) Pub. No.: US 2019/0196505 A1
(43) Pub. Date: Jun. 27, 2019

(54) SYSTEMS AND METHODS FOR LOADING AND UNLOADING MERCHANDISE USING AUTONOMOUS GROUND VEHICLES

(71) Applicant: Walmart Apollo, LLC, Bentonville, AR (US)

(72) Inventors: Donald R. High, Noel, MO (US); John J. O'Brien, Farmington, AR (US)

(21) Appl. No.: 16/228,055

(22) Filed: Dec. 20, 2018

Related U.S. Application Data
(60) Provisional application No. 62/610,604, filed on Dec. 27, 2017.

(51) Int. Cl. G05D 1/02; G05D 1/00; B65G 67/08; B65G 67/24

(52) U.S. Cl. CPC G05D 1/0291; G05D 1/0022; G05D 1/0027; B65G 2201/02; B65G 67/24; G05D 2201/0213; G05D 1/0088; B65G 67/08

(57) ABSTRACT

In some embodiments, apparatuses and methods are provided herein useful for the loading and unloading of merchandise using a plurality of autonomous ground vehicles (AGVs). In some embodiments, the system includes: a plurality of AGVs; a first, disassembled orientation of the AGVs; a second, assembled orientation of the AGVs in which they define a chain of AGVs; a task database containing a transfer specification for the AGVs; and a central computer system for determining that the AGVs satisfy the transfer specification and for instructing movement of the AGVs. Each AGV control circuit moves an AGV to the transfer location coordinates; arranges the AGV in a sequential order within the chain of AGVs; causes the AGV to orient its conveyor assembly; causes the AGV to receive a merchandise item on its conveyor assembly from an upstream AGV; and causes the AGV to transfer the merchandise item to a downstream AGV.

### CROSS-REFERENCE TO RELATED APPLICATION

This application claims the benefit of U.S. Provisional Application No. 62/610,604, filed Dec. 27, 2017, which is incorporated by reference in its entirety herein.

### TECHNICAL FIELD

This invention relates generally to transferring merchandise using autonomous ground vehicles, and more particularly, to loading and unloading merchandise using autonomous ground vehicles having conveyor assemblies.

### BACKGROUND

In the retail setting, one area that is of significance is the loading and unloading of merchandise at distribution centers to and from delivery vehicles, such as delivery trucks. This loading and unloading of merchandise must be handled in an efficient manner so that the merchandise may be transported and delivered to stores and to customers in a timely manner. When there are delays in the loading and loading process, the merchandise may not be received when needed or when scheduled for delivery.

It would be desirable to use autonomous ground vehicles in the loading and unloading of merchandise. Autonomous ground vehicles are often interchangeable, and a group of AGVs may be used to define a chain extending from a starting point to a transfer point for the loading/unloading. There is a need for the use of autonomous ground vehicles at stores and distribution centers to make the loading and unloading process more efficient.

### BRIEF DESCRIPTION OF THE DRAWINGS

Disclosed herein are embodiments of systems, apparatuses and methods pertaining to the loading and unloading of merchandise using a plurality of autonomous ground vehicles. This description includes drawings, wherein:

FIG. 1 is a schematic diagram in accordance with some embodiments;

FIG. 2 is a block diagram in accordance with some embodiments;

FIG. 3 is a block diagram in accordance with some embodiments;

FIG. 4 is a flow diagram in accordance with some embodiments;

FIG. 5 is a block diagram in accordance with some embodiments;

FIG. 6 is a flow diagram in accordance with some embodiments;

FIG. 7 is a block diagram in accordance with some embodiments;

FIG. 8 is a schematic diagram in accordance with some embodiments;

FIG. 9 is a flow diagram in accordance with some embodiments; and

FIG. 10 is a block diagram in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for the loading and unloading of merchandise using a plurality of autonomous ground vehicles. In some embodiments, there is provided a system comprising: a plurality of autonomous ground vehicles (AGVs) for transferring a merchandise item, each AGV comprising: a motorized locomotion system configured to facilitate movement of the AGV;

a navigational system for guiding the movement of the AGV; one or more sensors for determining the AGV's position relative to other objects; a conveyor assembly for the movement of the merchandise item from one AGV to another AGV; a transceiver configured for wireless communication; and an AGV control circuit operatively coupled to the motorized locomotion system, the navigational system, the one or more sensors, the conveyor assembly, and the transceiver, the control circuit configured to operate and move the AGV; a first, disassembled orientation of the plurality of AGVs in which at least one of the plurality of AGVs is not linked to another AGV; a second, assembled orientation of the plurality of AGVs in which the AGVs are linked to one another to define a chain of AGVs extending from an initial starting position for the merchandise item to a final transfer position for the merchandise item; a task database containing a transfer specification for the plurality of AGVs, the transfer specification comprising location coordinates for the transfer of the merchandise item, time for the transfer of the merchandise item, capabilities required for the plurality of AGVs, and the required length of the plurality of AGVs in the second orientation; and a central computer system communicatively coupled to the task database and each AGV control circuit, the central computer system configured to: determine that the capabilities of the plurality of AGVs and the length of the plurality of AGVs in the second orientation satisfies the transfer specification; and instruct each AGV control circuit to move the AGV to the location coordinates at the time for transfer of the merchandise item; wherein each AGV control circuit is configured to: cause the AGV to move to the location coordinates at the time for transfer of the merchandise item; arrange the AGV in a sequential order within the chain of AGVs in the second orientation; cause the AGV to orient its conveyor assembly at a predetermined height and inclination; cause the AGV to receive the merchandise item on its conveyor assembly from an upstream AGV in the chain when the AGV is not at the initial starting position; and cause the AGV to transfer the merchandise item on its conveyor assembly to a downstream AGV in the chain when the AGV is not at the final transfer position.

In the system, in some implementations, the transfer specification is a numeric string with separate numeric values in the string identifying location coordinates for the transfer of the merchandise item; start time, stop time, and duration for the transfer of the merchandise item; capabilities required for the plurality of AGVs; and the required length of the plurality of AGVs in the second orientation. In some implementations, the location coordinates represent specific unique position coordinates for each AGV to define a specific predetermined arrangement of the AGVs in the second orientation. In some implementations, each AGV control circuit is configured to: move the AGV to its unique position in the predetermined arrangement of the AGVs; and communicate with the central computer system to confirm when the AGV is in its unique position. In some implementations, a first AGV control circuit is configured to move a first AGV to a first position in the delivery chain and to announce its position to the other AGV control circuits; and a second AGV control circuit is configured to use a second AGV's one or more sensors to move the second AGV to a second position adjacent the first AGV. In some implementations, the capabilities required for the plurality of AGVs comprise one or more of: whether rollers are required for movement of the merchandise item, the required weight capacity of the AGVs to transfer the merchandise item, and whether a scanner is required to read and identify the merchandise item. In some implementations, the numeric string includes additional numeric values representing each AGV's predetermined position within the delivery chain and representing the angle of inclination of a first conveyor assembly at the initial starting position and the angle of inclination of a second conveyor assembly at the final transfer position. In some implementations, each AGV control circuit is configured to communicate the capabilities of the AGV to the central computer system; the central computer system is configured to access the task database to determine the capabilities required in the transfer specification; and the central computer system is configured to select the plurality of AGVs to perform the transfer if the capabilities of each AGV satisfies the capabilities required in the transfer specification. In some implementations, each AGV further comprises a hydraulic piston operatively coupled to the AGV control circuit and the AGV conveyor assembly, the hydraulic piston configured to allow adjustment of the height or inclination of the AGV conveyor assembly. In some implementations, the initial starting location is one of a delivery vehicle or a product bin and the final transfer location is the other of the delivery vehicle or the product bin.

In another form, there is provided a method for the loading and unloading of merchandise using a plurality of autonomous ground vehicles, the method comprising: providing a plurality of autonomous ground vehicles (AGVs) for transferring a merchandise item, each AGV comprising: a motorized locomotion system configured to facilitate movement of the AGV; a navigational system for guiding the movement of the AGV; one or more sensors for determining the AGV's position relative to other objects; a conveyor assembly for the movement of the merchandise item from one AGV to another AGV; a transceiver configured for wireless communication; an AGV control circuit operatively coupled to the motorized locomotion system, the navigational system, the one or more sensors, the conveyor assembly, and the transceiver, the control circuit configured to operate and move the AGV; forming a first, disassembled orientation of the plurality of AGVs in which at least one of the plurality of AGVs is not linked to another AGV; forming a second, assembled orientation of the plurality of AGVs in which the AGVs are linked to one another to define a chain of AGVs extending from an initial starting position for the merchandise item to a final transfer position for the merchandise item; providing a task database containing a transfer specification for the plurality of AGVs, the transfer specification comprising location coordinates for the transfer of the merchandise item, time for the transfer of the merchandise item, capabilities required for the plurality of AGVs, and the required length of the plurality of AGVs in the second orientation; by a central computer system: determining that the capabilities of the plurality of AGVs and the length of the plurality of AGVs in the second orientation satisfies the transfer specification; and instructing each AGV control circuit to move the AGV to the location coordinates at the time for transfer of the merchandise item; and by each control circuit: causing the AGV to move to the location coordinates at the time for transfer of the merchandise item; arranging the AGV in a sequential order within the chain of AGVs in the second orientation; causing the AGV to orient its conveyor assembly at a predetermined height and inclination; causing the AGV to receive the merchandise item on its conveyor assembly from an upstream AGV in the chain when the AGV is not at the initial starting position; and causing the AGV to transfer the merchandise item on its conveyor assembly to a downstream AGV in the chain when the AGV is not at the final transfer position.

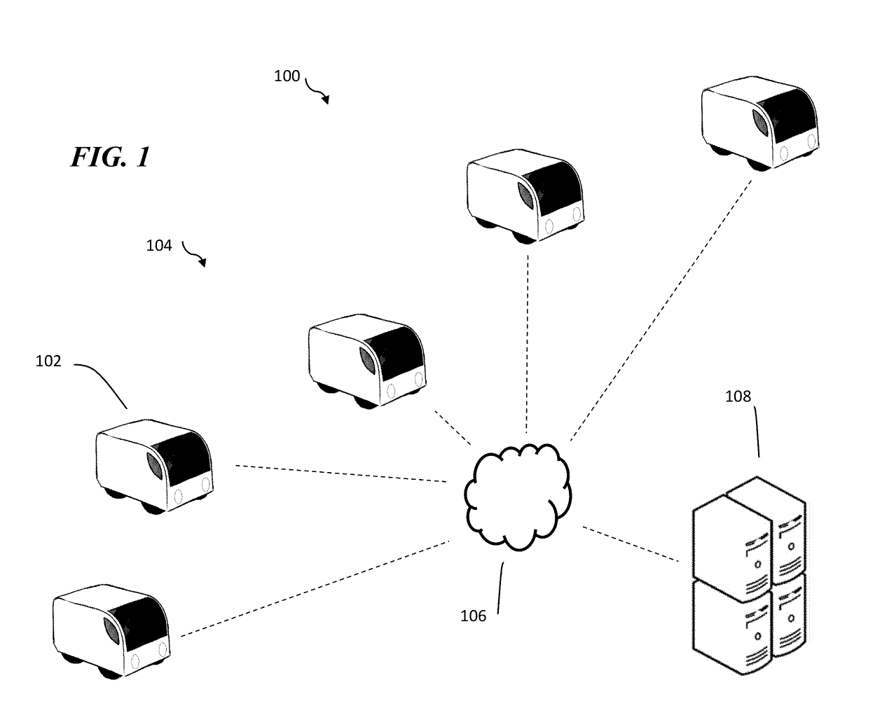

Referring to FIG. 1, there is shown a system 100 in which multiple AGVs 102 cooperate in order to form an overall conveyor structure from an initial starting position to a final transfer position for a merchandise item. For example, the multiple AGVs 102 may cooperate in order to define a conveyor structure between an initial starting position in the form of a delivery vehicle and a final transfer position in the form of a product bin. As addressed further below, each AGV 102 has a conveyor assembly that forms part of the AGV 102. It is contemplated that the AGVs will initially be in a generally disassembled orientation 104 in which the AGVs 102 are not linked to one another (as shown in FIG. 1) and will receive instructions and location coordinates to move to a desired location where the loading or unloading is to occur. The AGVs 102 are instructed to form an assembled orientation of the AGVs 102 in which they are linked to one another to define a chain of AGVs 102 extending from the initial starting position for the merchandise item to the final transfer position for the merchandise item.

In this manner, the AGVs 102 may facilitate the loading or unloading of merchandise, such as might occur, for example, at product distribution centers or stores. In this particular example, there are five AGVs that are in a disassembled orientation 104 (although other numbers of AGVs may also be utilized) and that will assemble in a sequential order in an end-to-end or side-by-side manner to form the overall conveyor structure. In the disassembled orientation, it is generally contemplated that all of the AGVs are separated from another. It is also contemplated that a few of the AGVs 102 may be linked to one another but that, at least, one of the AGVs 102 will not be linked. In the system 100, the AGVs 102 may communicate with one another over a network 106. The system 100 may include a central computer system 108 accessible by one or more of the AGVs 102 over the network 106.

The system 100 is directed generally to AGVs 102 each having a built-in conveyor assembly to help with the automated loading or unloading of the AGV with packages from trucks, warehouse environments, etc. In one form, the conveyor assembly may be a detachable and modular conveyor belt assembly that will assist in package transport from the loading and unloading of trucks, warehouse environments, etc. For example, the conveyor assembly could operate like a compact disk tray where the conveyor is housed within the AGV 102 and slides out for use or the conveyor assembly could be mounted on the top of the AGV 102.

In one form, the AGVs 102 may each be equipped with a conveyor assembly having sensors and the collective ability to load or unload a truck. The AGV mounted conveyor assemblies could raise and lower to match vehicle height requirements and also rotate up or down to enable the unloading of trailers. A group of AGV conveyor assemblies could autonomously form a conveyor structure where the products entering the system 100 are auto-sensed, for example, by UPC, barcode, RFID, video analytics, magnetic ink, or other means.

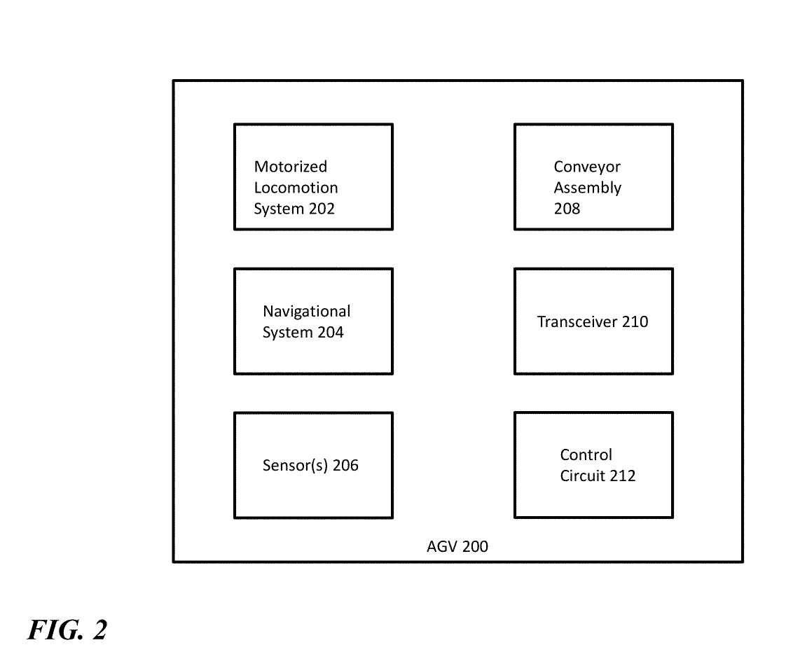

Referring now to FIG. 2, an AGV 200 for use in transporting/conveying merchandise in accordance with some embodiments is shown. It is generally contemplated that the AGV 200 includes certain components that allow it to convey merchandise. The AGV 200 includes a motorized locomotion system 202, a navigational system 204, sensor(s) 206 for determining the AGV's position relative to other objects, a conveyor assembly 208, a transceiver 210, and a control circuit 212. In some embodiments, the AGV 200 may also include a storage compartment and may be configured to carry packages and/or other types of cargo. The AGVs 200 may be generally interchangeable with one another, but it is also contemplated that some of the AGVs 200 may have different characteristics that make them especially appropriate in certain loading/unloading circumstances.

The AGV 200 includes a motorized locomotion system 202 configured to facilitate movement of the AGV 200. It is generally contemplated that the motorized locomotion system 202 may include wheels (or tracks or legs), a motor, and a drive mechanism. The AGVs 200 each include a power source (such as a battery or solar cell) disposed in the vehicle body to energize its motorized locomotion system 202 and other components. The motorized locomotion system 202 may comprise one or more motors that control one or more of a speed, direction, and/or orientation of one or more wheels (or tracks or legs) on the AGV 200. The motorized locomotion system 202 may be configured to be controlled by the control circuit 212 to move the AGV 200 in designated directions.

The AGV 200 includes a navigational system 204 for guiding the AGV 200 along its path. The navigational system 204 includes sensor(s) for navigation and optionally for detecting obstacles in the AGV's path as it travels along its route. These sensor(s) may be of any of various types, including compasses and other navigational aids, gyroscopes, magnetometers, accelerometers, radar laser range finders, ultrasound range finders, infrared sensors, and optical/imaging sensors (such as video/camera devices). It is also generally contemplated that the optical/imaging sensors may permit a human operator to remotely guide the AGV 200.

As part of and in addition to the navigational sensors, the AGV 200 also includes sensor(s) 206 for determining the AGV's position relative to other objects. These sensor(s) aid in the avoidance of objects as the AGV 200 travels to the loading or unloading area. In addition, it is also contemplated that these sensor(s) 206 may aid the AGV 200 as it makes minute adjustments to its position in the sequential arrangement of AGVs 200 when the AGVs 200 are moving into an assembled/linked orientation.

Each AGV 200 also includes an integrated conveyor assembly 208 that forms part of the AGV. When the AGVs 200 are arranged in their sequential, assembled position, these conveyor assemblies will cooperate to form an overall conveyor system for moving the merchandise. In one form, it is contemplated that each AGV 200 will be equipped with a modular and attachable/detachable conveyor assembly 208. Further, in one form, it is contemplated that each conveyor assembly 208 is adjustable to a desired height and inclination to facilitate cooperation of the conveyor assemblies 208 of the AGVs 200 with one another.

The AGV 200 further includes a transceiver 210 configured for wireless communication. The transceiver 210 may comprise one or more of a WLAN transceiver, a WWAN transceiver, a mobile data network transceiver, a satellite network transceiver, a WiMax transceiver, a Wi-Fi transceiver, a Bluetooth transceiver, and the like. In some embodiments, the transceiver 210 may be configured to allow the control circuit 212 to communicate with the other AGVs 200 and a central computer system.

In addition, the AGV 200 includes a control circuit 212 operatively coupled to the motorized locomotion system 202, the navigational system 204, the sensor(s) 206, the conveyor assembly 208, and the transceiver 210. The control circuit 212 is configured to operate and move the AGV 200. The control circuit 212 may comprise a processor, a microprocessor, and the like and may be configured to execute computer readable instructions stored on a computer readable storage memory. The computer readable storage memory may comprise volatile and/or non-volatile memory and have stored upon it a set of computer readable instructions which, when executed by the control circuit 212, cause the control circuit 212 to navigate the AGV 200 and communicate with other devices. The architectural options for such structures are well known and understood in the art and require no further description here. The control circuit 212 is configured (for example, by using corresponding programming as will be well understood by those skilled in the art) to carry out one or more of the steps, actions, and/or functions described herein.

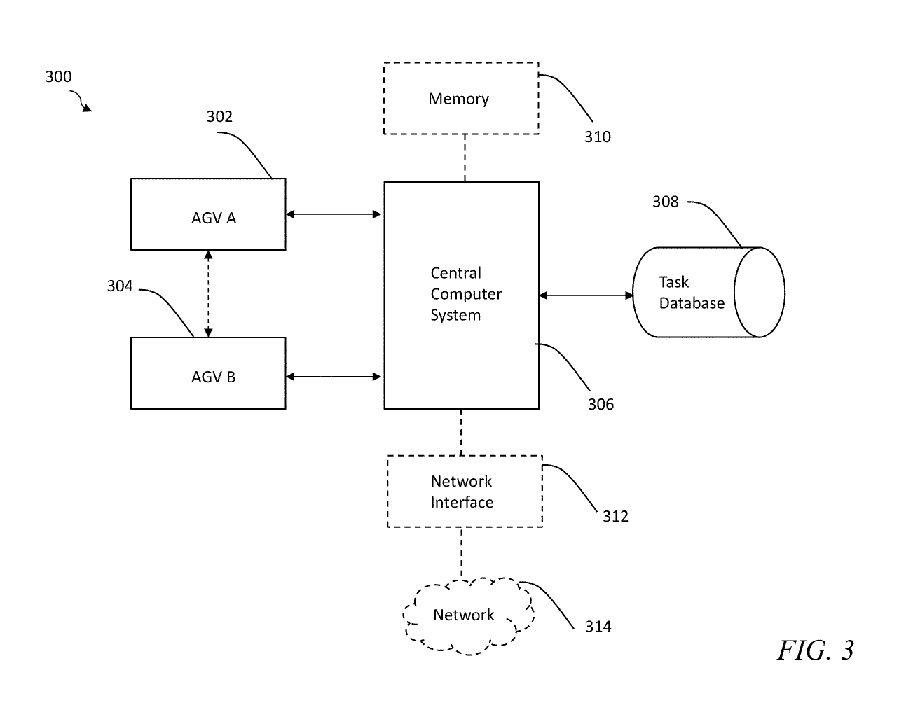

Referring now to FIG. 3, there is shown a system 300 for arranging AGVs with conveyor assemblies in a sequential order to form a conveyor assembly chain for loading and unloading merchandise. FIG. 3 shows the interaction of some components of the system 300 and also incorporates the components shown in FIGS. 1 and 2. As shown in FIG. 3, there are two AGVs (AGV A (302) and AGV B (304)) that may communicate with one another, but as should be evident, it is contemplated that additional AGVs may be used in the system 300 (that may also communicate with one another). Each AGV communicates with a central computer system 306 that provides the AGV with loading and unloading instructions. In other words, the central computer system 306 is communicatively coupled to each AGV control circuit 212. As addressed further below, the central computer system 306 is also communicatively coupled to a task database 308 that includes data relating to particular loading and unloading tasks.

The task database 308 contains a transfer specification for the plurality of AGVS, which provides the specific data for a loading/unloading task. For example, the transfer specification may include location coordinates for the transfer of the merchandise item, the time for the transfer of the merchandise item, the capabilities required for the plurality of AGVs, and the required length of the plurality of AGVs in the second (assembled) orientation. It is generally contemplated that the task database may contain a number of transfer specifications for multiple loading/unloading tasks, which may be continually updated as more loading and unloading tasks are planned.

As addressed above, the system 300 also includes central computer system 306, which instructs the AGVs and which determines if the AGVs satisfy the transfer specification in the task database 308. More specifically, as addressed further below, the central computer system 306 is configured to determine that the capabilities of the plurality of AGVs satisfy the transfer specification and that the length of the AGVs in the second (assembled) orientation satisfies the transfer specification. For example, it may be determined that five AGVs arranged side-by-side provide sufficient length for the loading or unloading task. In addition, the central computer system 306 is configured to instruct each AGV control circuit 212 to move the AGV to the location coordinates at the time for transfer of the merchandise item.

As described herein, the language “central computer system” refers broadly to a system including any microcontroller, computer, or processor-based devices with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The central computer system 306 may be configured (for example, by using corresponding programming stored in a memory as will be well understood by those skilled in the art) to carry out one or more of the steps, actions, and/or functions described herein.

As shown in FIG. 3, the central computer system 306 may be coupled to a memory 310, a network interface 312, and network(s) 314. The memory 310 can, for example, store non-transitorily computer instructions that cause the central computer system 306 to operate as described herein, when the instructions are executed, as is well known in the art. Further, the network interface 312 may enable the central computer system 306 to communicate with other elements (both internal and external to the system 300). This network interface 312 is well understood in the art. The network interface 312 can communicatively couple the central computer system 306 to whatever network or networks 314 may be appropriate for the circumstances. In this form, it is contemplated that the central computer system 306 may access one or more databases (including task database 308) to collect data for performing its functions.

The central computer system 306 communicates with and cooperates with the AGV control circuits 212 so that the AGVs 200 can perform the loading/unloading task. More specifically, each AGV control circuit 212 is configured to: cause the AGV 200 to move to the location coordinates at the time for transfer of the merchandise item; arrange the AGV 200 in a sequential order within the chain of AGVs 200 in the assembled orientation; cause the AGV 200 to orient its conveyor assembly 208 at a certain height and inclination; cause the AGV 200 to receive the merchandise item on its conveyor assembly 208 from an upstream AGV 200 in the chain when the AGV 200 is not at the initial starting position; and cause the AGV 200 to transfer the merchandise item on its conveyor assembly 208 to a downstream AGV 200 in the chain when the AGV 200 is not at the final transfer position.

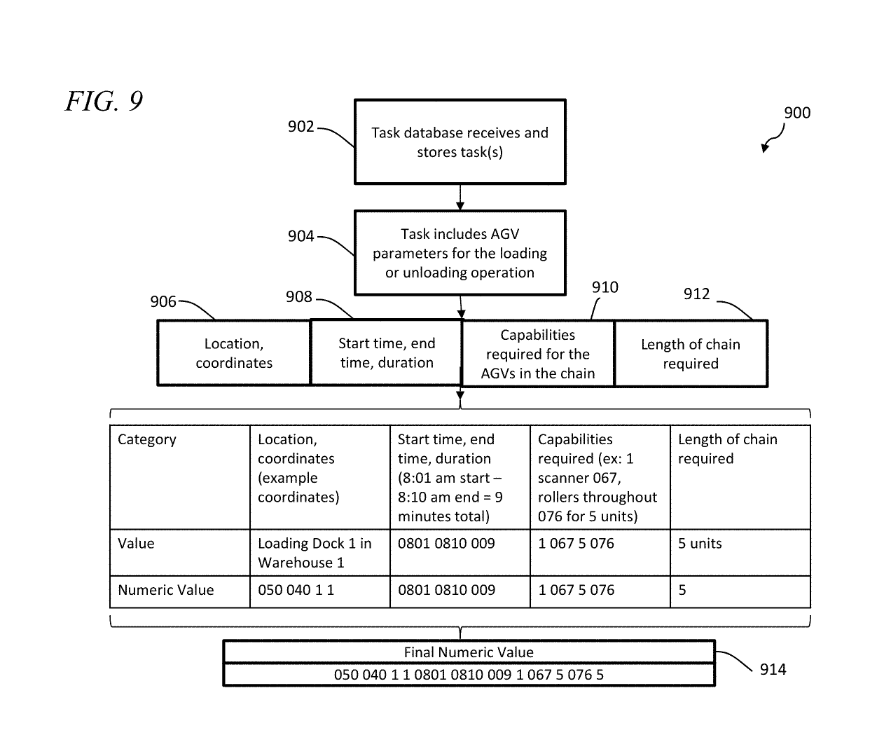

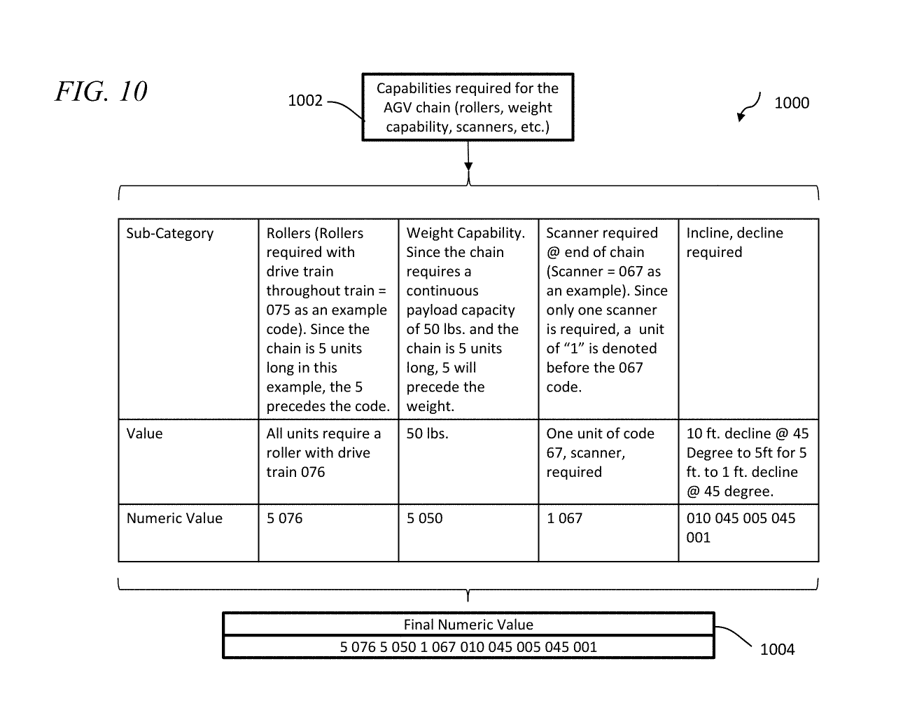

In one form, it is contemplated that the transfer specification for each loading/unloading task includes values representing transfer location and time, AGV capabilities, and/or the length of the AGV chain. For example, the transfer specification may be in the form of a numeric string with separate numeric values in the string identifying location coordinates for the transfer of the merchandise item; start time, stop time, and duration for the transfer of the merchandise item; capabilities required for the plurality of AGVs; and/or the required length of the plurality of AGVs in the assembled orientation. In one form, the numeric string may include unique position coordinates and the predetermined arrangement for AGVs 200 in the chain. In other words, the location coordinates may represent specific unique position coordinates for each AGV 200 to define a specific predetermined arrangement of the AGVs 200 in the assembled orientation. Further, each AGV control circuit 212 may be configured to: move the AGV 200 to its unique position in the predetermined arrangement of AGVs 200; and communicate with the central computer system 206 to confirm when the AGV 200 is in its unique position. One specific example of a numeric string with these numeric values is described further below. (See also FIGS. 9 and 10.)

In addition, it is generally contemplated that the AGVs 200 move into their final positions in the chain using proximity sensors that assist in determining the nearby locations of other AGVs 200. For example, a first AGV control circuit 212 may be configured to move a first AGV 200 to a first position in the delivery chain and to announce its position to the other AGV control circuits 212. In this example, a second AGV control circuit 212 is configured to use that AGV's sensor(s) to move the second AGV 200 to a second position adjacent the first AGV 200.

Further, it is generally contemplated that each AGV 200 may have different capabilities, which may have to satisfy AGV requirements in the task database 308 for a specific loading/unloading task. For example, these AGV capabilities and requirements may relate to characteristics of the AGVs, such as rollers, weight capacity, and scanners. In other words, the capabilities required for some or all of the AGVs may include one or more of: whether rollers are required for movement of the merchandise item, the required weight capacity of the AGVs 200 to transfer the merchandise item, and whether a scanner is required to read and identify the merchandise item.

Also, the transfer specification for a particular loading/unloading task may include the requisite angle of inclination of conveyors at the start and/or end of the chain. For instance, where the transfer specification is in the form of a numeric string, the numeric string may include numeric values representing each AGV's predetermined position within the delivery chain and/or representing the angle of inclination of a first conveyor assembly 208 at the initial starting position and/or the angle of inclination of a second conveyor assembly 208 at the final transfer position. Each AGV 200 may include a hydraulic piston that facilitates adjustment of the AGV's conveyor assembly 208. In other words, each AGV 200 may include a hydraulic piston operatively coupled to the AGV control circuit 212 and the AGV conveyor assembly 208 with the hydraulic piston being configured to allow adjustment of the height and/or inclination of the AGV conveyor assembly 208.

In addition, it is generally contemplated that the central computer system 306 may select the AGVs 200 that meet the task requirements in the task database 308. In other words, each AGV control circuit 212 may be configured to communicate the capabilities of the AGV 200 to the central computer system 306; the central computer system 306 may be configured to access the task database 308 to determine the capabilities required in the transfer specification; and the central computer system 306 may be configured to select the AGVs 200 to perform the transfer if the capabilities of each AGV 200 satisfies the capabilities required in the transfer specification. As should be evident, the system 300 may be used to perform a variety of different loading and unloading activities, such as, for example, unloading from a delivery truck to a product bin at a retail store. In other words, in one example, the initial starting location may be a delivery vehicle and the final transfer location may be a product bin (for unloading), or conversely, the initial starting location may be the product bin and the final transfer location may be the delivery vehicle (for loading).

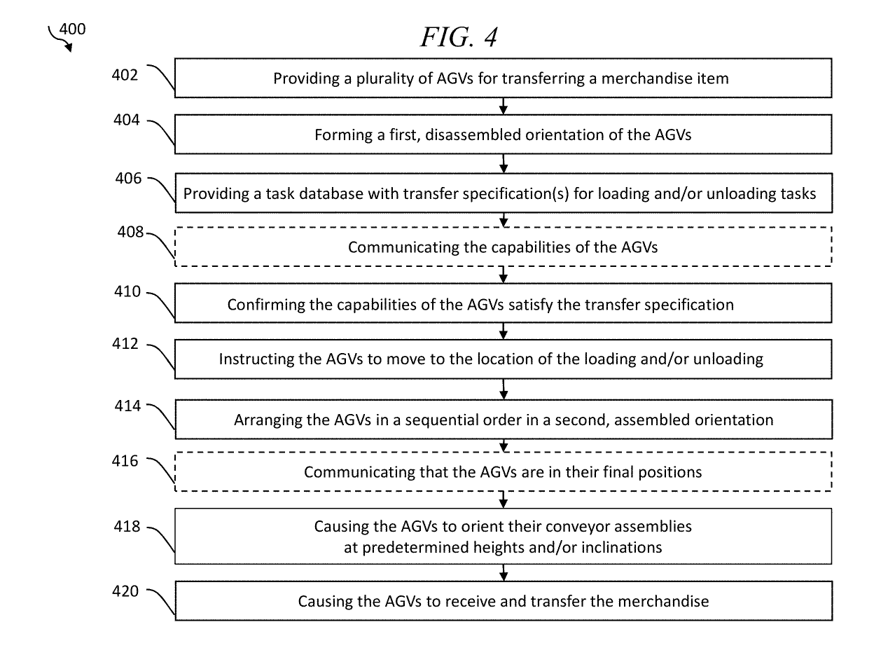

Referring to FIG. 4, there is shown a process 400 for using multiple AGVs to cooperate to accomplish the transfer of merchandise during a loading or unloading operation. As described above, it is generally contemplated that this loading/unloading operation may be performed at a product distribution center or at a store, such as loading and/or unloading a delivery truck. This process generally involves arranging the AGVs in an assembled orientation and using a conveyor assembly on each AGV in a cooperative manner to create a conveyor structure for the loading and/or unloading of merchandise. Some of the components described above in systems 100 and 300 (and with respect to the AGVs 200) may be used.

At block 402, a plurality of AGVs for transferring a merchandise item are provided. In one form, it is generally contemplated that AGVs having the components of AGVs 200 described above may be used. For example, there may be a substantial quantity of AGVs located at the site of the loading or unloading, such as a product distribution or store, and as addressed further below, a certain number of these AGVs may be selected to perform the loading/unloading operation. It is generally contemplated that the AGVs are generally similar and interchangeable, but there may be some AGVs having different characteristics to suit certain particular loading/unloading circumstances.

At block 404, the plurality of AGVs are formed in a disassembled orientation. In other words, it is generally contemplated that the AGVs will not already be linked together to form a chain, as required for the loading or unloading. Instead, it is generally contemplated that the individual AGVs will each be performing other, separate tasks (such as delivering merchandise to a customer or transferring individual merchandise items to different parts of a product distribution center or store). Alternatively, the AGVs may be idle and awaiting instructions for a task. Some of the AGVs may already be linked to one another (such as for performing a previous loading/unloading operation or some other task), but it is generally contemplated that, at least, some of the AGVs will need to be linked to the other AGVs to perform the loading/unloading operation.

At block 406, a task database is provided with one or more transfer specifications corresponding to each loading/unloading task. In one form, it is contemplated that each transfer specification may be in the form of a numeric string with separate numeric values corresponding to predetermined requirements for the loading/unloading operation arranged in a predetermined order. For example, the numeric string may contain numeric values identifying location coordinates for the loading/unloading task (i.e., the location of the transfer of the merchandise); the time of the loading/unloading (such as, for example, the start time, stop time, and duration for the transfer of the merchandise); the capabilities required for some or all of the AGVs; and the number of AGVs needed (i.e., the required length of the plurality of AGVs in an assembled orientation). Further, the capabilities required for the AGVs may include, for example, one or more of: whether rollers are required for movement of the merchandise, the required weight capacity of the AGVs to transfer the merchandise, and whether a scanner is required to read and identify the merchandise.

At block 408, optionally, each AGV may communicate its capabilities, such as to a central computer system. In this form, it is contemplated that each AGV's capabilities is stored at the AGV, and the AGV will communicate these capabilities to the central computer system. However, in an alternative form, it is also contemplated that each AGV's capabilities may be stored on a database accessible to the central computer system. In this alternative form, the central computer system may use an AGV identifier to look up the capabilities of each AGV.

At block 410, the central computer system confirms that the capabilities of the AGVs satisfy the requirements of the transfer specification. For example, the transfer specification may require that all AGVs have rollers for movement of the merchandise. The central computer system compares this roller requirement to the capability of each AGV and may accept or reject the AGV as a candidate for the loading/unloading operation based on this comparison. As another example, the transfer identification may include a required weight capacity of the AGVs to transfer the merchandise, such as, for example, 100 pounds. Again, the central computer system may compare this required weight capacity to an AGV's capability, and if, for example, the AGV capability is 50 pounds, the central computer system would reject that particular AGV for this particular loading/unloading task. Once the AGV capabilities are confirmed, it is contemplated that the AGVs participating in the loading/unloading operation may be identified and selected.

At block 412, the participating AGVs are instructed to move to the location of the loading or unloading. For example, the central computer system may instruct each AGV control circuit to move the AGV to the location coordinates at the time for transfer of the merchandise based on the requirements of the transfer specification. In turn, each AGV control circuit may cause the AGV to move to the location coordinates at the time for transfer of the merchandise. In one form, it is generally contemplated that each participating AGV may move to and congregate at the common loading/unloading location from their separate starting positions.

At block 414, the AGVs are arranged in sequential order in an assembled orientation. It is generally contemplated that the AGVs will be arranged end-to-end or side-by-side in a chain extending from a starting position (for the loading/unloading) to a final transfer position (for the loading/unloading). In one form, the AGVs may use their navigation systems to move to their predetermined, specific unique position coordinates. Further, it is generally contemplated that the AGVs will include proximity and obstacle avoidance sensors that will enable them to avoid collisions and to arrange themselves in close proximity to one another. In one form, it is contemplated that the AGVs will communicate with one another to announce their positions and to facilitate the positioning of subsequent AGVs arranging themselves in the chain. At block 416, when the AGVs are arranged, they may, optionally, communicate that they are in their final, unique positions to the central computer system.

At block 418, the AGVs each orient their conveyor assemblies to predetermined heights and/or inclinations. For example, the AGVs may each raise their conveyor assemblies a height of one meter but without any inclination (i.e., at a horizontal orientation). As an alternative example, each AGV may orient its conveyor assembly at a slight inclination (such as, for example, five degrees), but each AGV will then orient its conveyor assembly at a different height that incrementally increases or decreases as one proceeds along the chain of linked AGVs. It should also be understood that this step may occur earlier during the process 400.

At block 420, once the AGVs are in position and the conveyor structure is formed, the AGVs receive and transfer merchandise along the chain. So, the first AGV in the chain (at the starting position) will receive the merchandise that is being loaded or unloaded on its conveyor assembly and will transfer the merchandise to the second AGV in the chain. The second AGV will receive the merchandise on its conveyor assembly and will transfer the merchandise to a third AGV, and this receipt and transfer will continue until the merchandise is transferred to the final AGV in the chain (at the transfer position).

In one form, it is generally understood that some of the steps of the process 400 may require oversight and/or additional intervention by a human operator. For example, after the AGVs arrange themselves in sequential order in the chain, a human operator may be desirable to confirm the arrangement and/or provide some slight adjustment to the AGV positions. As an additional example, a human operator may be involves to link or couple the conveyor assemblies of the AGVs when they are moved to their intended heights and/or inclinations. However, it is generally contemplated that much of the arrangement of the conveyor structure required for loading/unloading has been accomplished by process 400.

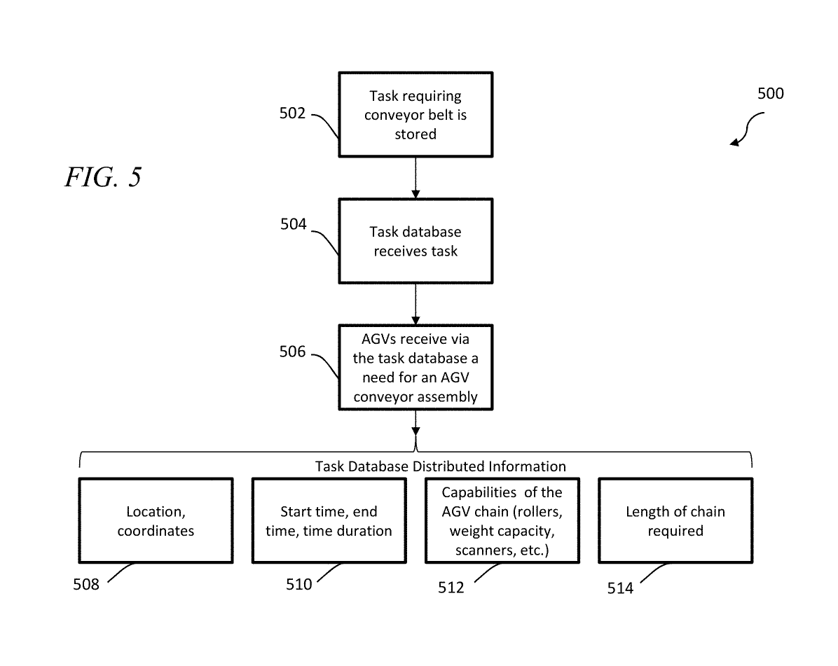

FIGS. 5-10 provide some specific examples of certain preferred aspects of the systems 100 and 300 and process 400 described above. They are intended to provide additional illustrations of specific possible aspects and implementations. The description below regarding FIGS. 5-10 incorporates and supplements the description above of systems 100 and 300, process 400, and AGV 200.

Referring to FIG. 5, there is shown a high-level overview of a process 500 using some of the components described above. At blocks 502 and 504, it is contemplated that a task requiring the use of a conveyor belt structure is stored in a task database. In one form, it is contemplated that multiple tasks may be stored in task database at various times. For example, a store or distribution center may input tasks into the task database after the store or distribution center receives a delivery schedule of when delivery trucks will arrive at the store or distribution center with merchandise requiring unloading.

At block 506, the AGVs receive a loading/unloading instruction indicating a need for AGVs having conveyor assemblies that can be utilized in the loading/unloading operation. In one form, as described above, a central computer system may access the tasks in the task database and transmit instructions to the individual AGVs capable of performing the loading/unloading. In response, the AGVs use the data from the task database to proceed to the loading/unloading area and to cooperate together to perform the loading/unloading.

At blocks 508, 510, 512, and 514, some possible data parameters are shown that may be stored in the task database. The central computer system and/or the AGVs use these data parameters to perform each particular loading/unloading operation. In one form, it is contemplated that these data parameters of each task may be stored in a transfer specification in the form of a numerical string of values.

At block 508, in this example, the numerical string may include the location and coordinates of the loading/unloading operation (such as a particular loading) dock to which the AGVs must proceed. At block 510, the time of the scheduling loading/unloading operation may be provided and may include one or more of the start time, end time, and duration of the loading or unloading. At block 512, the capabilities of the AGVs required for this particular loading/unloading operation may be provided, such as, for example, the need for rollers, the weight capacity, and the need for scanners. At block 514, the total length of the AGV chain, i.e., the number of AGVs required, may be provided. It is generally contemplated that these data parameters may be arranged in a predetermined order in the numerical string.

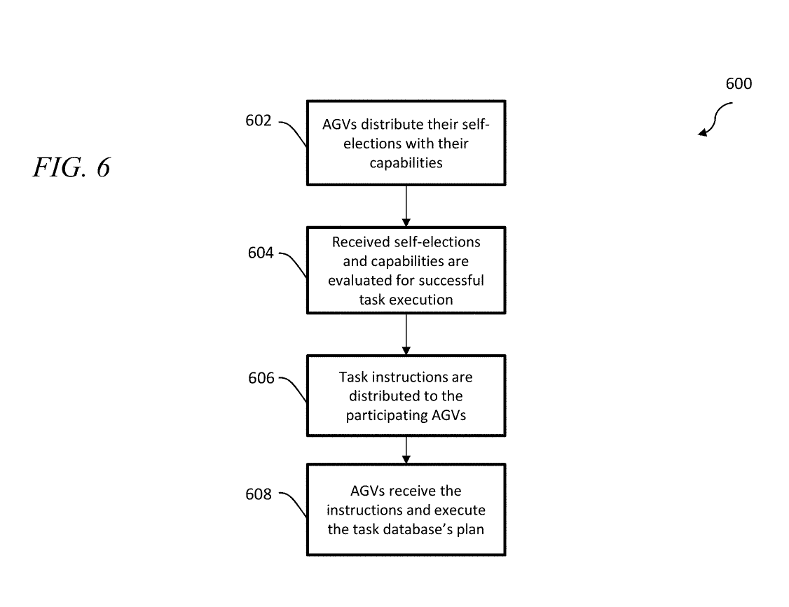

Referring to FIG. 6, there is shown another high-level overview of a process 600 focusing on certain aspects described above. At block 602, the AGVs may distribute “self-elections” regarding their capabilities and characteristics for a particular loading or unloading operation. This “self-election” may occur in various ways. In one way, it is contemplated that that the capabilities and characteristics of each AGV may have been previously stored in the task database. In another way, it is contemplated that the central computer system may query candidate AGVs about an upcoming loading or unloading operation, and in response, the AGVs may transmit their individual capabilities and characteristics to the central computer system. In yet another way, it is contemplated that the AGV itself may elect tasks for completion from the task database based on its capabilities (which may or may not be subject to confirmation by the central computer system or other oversight system).

At block 604, the received “self-selections” and capabilities may be evaluated in order to facilitate successful task execution. In one form, the capabilities of each AGV are evaluated against the required capabilities provided in a transfer specification of the task. It is contemplated that this evaluation may occur at various locations, such as by the AGVs themselves or by a central computer system. In one form, each AGV may determine if it satisfies the requisite capabilities and characteristics. In another form, the central computer system may select those candidate AGVs with capabilities and characteristics matching those capabilities and characteristics required in the transfer specification.

At block 606, once the participating AGVs are identified, the task instructions re distributed to the participating AGVs. The AGVs will use the data parameters that provide the details of the loading/unloading task in order to complete the task. At block 608, the AGVs receive the instructions (such as from the central computer system) and execute the plan outlined in the task database.

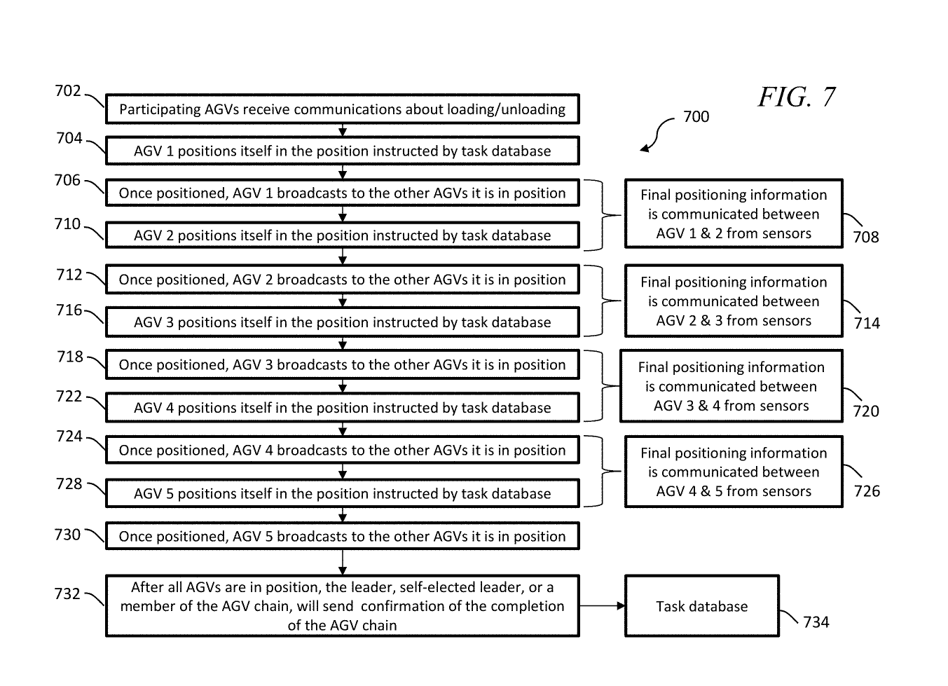

Referring to FIG. 7, there is shown a process 700 for the movement and positioning of the AGVs at the loading/unloading zone. At block 702, the participating AGVs receive communications about the loading or unloading operation. In one form, as described above, it is generally contemplated that these communications transmit data parameters from a task database. Also, it is contemplated that the capabilities of various candidate AGVs have been evaluated to determine whether they satisfy the requirements for the task. In this particular example, five AGVs have been selected for participation in the loading/unloading task.

At block 704, AGV1 positions itself in the (first) position dictated by the task database. In one form, it is contemplated that a central computer system accesses the particular task in the task database, accesses the position coordinates for AGV1, and transmits these position coordinates to AGV1. Alternatively, in another form, it is contemplated that the control circuit of AGV1 may directly access the task database to determine the position coordinates. AGV1 then moves to its intended position in the chain. At block 706, once positioned, AGV1 broadcasts to the other four AGVs that it is in its intended position so that they may then sequentially move to their intended positions. As shown at block 708, AGV1 may use sensors to determine and transmit its final position to some or all of the other AGVs.

At block 710, AGV2 positions itself in the (second) position of the chain, as dictated by the task database. Again, it may receive the position coordinates from a central computer system or by directly accessing the task database. As shown at block 708, it is generally contemplated that AGV2 may use its collision avoidance and positioning sensors to determine the final positioning information of AGV1. Again, these sensors may include any of various types of sensors, such as, for example, compasses and other navigational aids, gyroscopes, magnetometers, accelerometers, radar laser range finders, ultrasound range finders, infrared sensors, and optical/imaging sensors (such as video/camera devices). These sensors may aid AGV2 as it makes minute adjustments to its position next to AGV1 in the sequential arrangement of AGVs. At block 712, once positioned, AGV2 broadcasts to the other AGVs that it is in the (second) intended position of the chain and may include final positioning information as provided by its sensors.

At blocks 714-730, it is generally contemplated that this sequential positioning is repeated for AGV3, AGV4, and AGV5. More specifically, at blocks 714, 716, and 718, AGV3 positions itself next to AGV2 in the (third) intended position. AGV3 positions itself in the (third) intended position dictated by the task database, may use collision avoidance and positioning sensors to determine final positioning information regarding AGV2, and broadcasts to the other AGVs when it is in position (and may transmit its final positioning information). Next, AGV4 positions itself next to AGV3 in the (fourth) intended position. As shown at blocks 720, 722, and 724, AGV4 positions itself in the (fourth) intended position dictated by the task database, may use collision avoidance and positioning sensors to determine final positioning information with respect to AGV3, and broadcasts to the other AGVs when it is in position (and may transmit its final positioning information). Finally, AGV5 positions itself next to AGV4 in the (fifth and final) intended position. As shown at blocks 726, 728, and 730, AGV5 positions itself in the (fifth) intended position dictated by the task database, may use collision avoidance and positioning sensors to determine final positioning information next to AGV4, and broadcasts to the other AGVs when it is in position (and may transmit its final positioning information).

After all of the AGVs are in their intended positions in the chain, this status of completion of the chain may be communicated. In other words, there may be a communication indicating that all of the AGVs are in position and that the AGVs are ready for the loading/unloading operation to begin. As shown at block 732, this confirmation or ready status may be communicated by one or more of the AGVs, such as by a leader, a self-elected leader, or other member of the AGVs in the chain. It is contemplated that this confirmation may be communicated to the central computer system and/or the task database 734. The particular task in the task database 734 may be updated to reflect this ready confirmation.

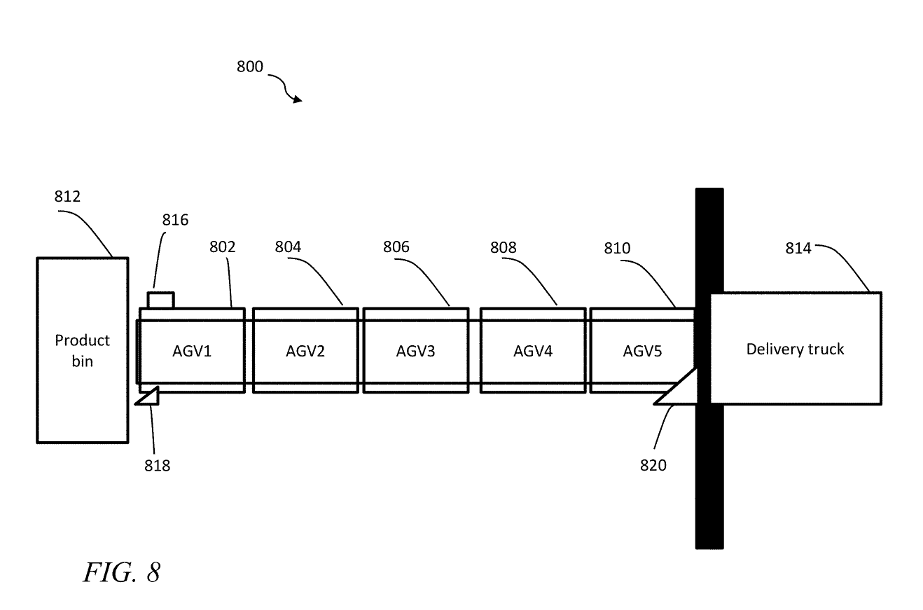

Referring to FIG. 8, there is shown a system 800 showing the five AGVs arranged sequentially in the loading/unloading chain. More specifically, in this particular example, the system 800 includes AGV1 (802), AGV2 (804), AGV3 (806), AGV4 (808), and AGV5 (810), which are arranged sequentially from left to right in FIG. 8. In this example, the AGV chain extends from a product bin 812 and a delivery truck 814, and merchandise from the delivery truck 814 is being unloaded into the product bin 812 from right to left in FIG. 8. In one form, it is generally contemplated that the five AGVs have been arranged sequentially one-by-one according to process 700 described above.

Further, in the example of system 800, it is contemplated that the characteristics and capabilities of the AGVs have been evaluated to make sure they satisfy the transfer specification requirements for this particular unloading task. So, in this example, AGV1 (802) includes a scanner 816 immediately prior to the product bin 812. In addition, in this example, each AGV must have rollers with a drive train and must also have a 50 pound payload capacity. In this example, it is contemplated that the three middle AGVs 804, 806, 808 will have horizontal conveyor assemblies but the two end AGVs 802, 810 will have inclinations. More specifically, in this particular example, the product bin 812 may be at a height of one foot while the delivery truck may be at a height of ten feet. So, AGV1 (802) may have a declining inclination 818 from five feet to one foot at a 45 degree angle at the end of the unloading chain, while AGV5 (810) may have a declining inclination 820 from ten feet to five feet at a 45 degree angle at the start of the unloading chain adjacent the delivery truck 814.

Referring to FIG. 9, there is shown an example of a high level overview process 900 where participating AGVs are determined for a loading or unloading task that needs to be performed. At block 902, the task database receives and stores task(s) for the loading or unloading of merchandise. At block 904, the task includes parameters for the AGVs that can participate in the loading or unloading operation. The actual selection of AGVs to participate in the loading or unloading task may be accomplished in various ways, as addressed above. However, it is generally contemplated that the capabilities and characteristics of AGVs needed for the operation (as contained in the task database) are matched against the actual capabilities and characteristics of candidate AGVs.

FIG. 9 shows an example of some of the types of AGV parameters that may be included in the task and how that information may be encoded. In this particular example, the transfer specification containing the required AGV parameters/categories includes four parameters: (1) location and/or coordinates of the loading or unloading operation 906; (2) start time, end time, and/or duration of the loading or unloading operation 908; (3) the AGV capabilities required to perform the loading or unloading operation 910; and (4) the length of the AGV required for the operation 912. As should be evident, these four parameters are just examples of the types of parameters (and arrangement of parameters) that may be encoded in the transfer specifications in the task database.

FIG. 9 shows some specific examples of values for these four parameters/categories. For example, the encoded numeric values are as follows: (1) the location of the loading or unloading (Loading Dock 1 in Warehouse 1) may correspond to “050 040 1 1;” (2) the time of the loading or unloading operation scheduled to start at 8:01 am and to end at 8:10 am (with a nine minute duration) may correspond to “0801 0810 009;” (3) the required AGV capabilities (including a scanner on one AGV and rollers on all five participating AGVs) may correspond to “1 067 5 076;” and (4) the required length of the AGV chain (five AGVs) may correspond to “5.” In this simple example, the final numeric value 914 for the transfer specification is the combination of these values: “050 040 1 1 0801 0810 009 1 067 5 076 5.”

FIG. 10 shows another example 1000 of a portion of a transfer specification such as was illustrated in FIG. 9. More specifically, FIG. 10 provides an example of the parameter/category capabilities required for the AGV 1002. In this particular example, the parameter/category has four sub-categories addressing four specific capabilities needed of the participating AGVs (rollers, weight capability, scanner requirement, and incline/decline). In this example, the encoded numeric values are as follows: (1) each of the five AGVs requires rollers with a drive train (“5 076”); (2) each of the five AGVs must have a weight capability or weight capacity of 50 pounds or more (“5 050”); (3) one of the AGVs must have a scanner at an end of the AGV chain (“1 067”); and (4) one of the AGVs must have a ten foot to five foot decline at 45 degrees and a second AGV must have a five foot to one foot decline at 45 degrees (“010 045 005 045 001”). So, in this particular example, the capabilities portion of the transfer specification may have a final numeric value 1004 of “5 076 5 050 1 067 010 045 005 045 001.” As should be evident, other sub-categories and arrangements of sub-categories are possible.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for the loading and unloading of merchandise using a plurality of autonomous ground vehicles, the system comprising:
a plurality of autonomous ground vehicles (AGVs) for transferring a merchandise item, each AGV comprising:
a motorized locomotion system configured to facilitate movement of the AGV;
a navigational system for guiding the movement of the AGV;
one or more sensors for determining the AGV's position relative to other objects;
a conveyor assembly for the movement of the merchandise item from one AGV to another AGV;
a transceiver configured for wireless communication;
an AGV control circuit operatively coupled to the motorized locomotion system, the navigational system, the one or more sensors, the conveyor assembly, and the transceiver, the control circuit configured to operate and move the AGV;
a first, disassembled orientation of the plurality of AGVs in which at least one of the plurality of AGVs is not linked to another AGV;
a second, assembled orientation of the plurality of AGVs in which the AGVs are linked to one another to define a chain of AGVs extending from an initial starting position for the merchandise item to a final transfer position for the merchandise item;
a task database containing a transfer specification for the plurality of AGVs, the transfer specification comprising location coordinates for the transfer of the merchandise item, time for the transfer of the merchandise item, capabilities required for the plurality of AGVs, and the required length of the plurality of AGVs in the second orientation;
a central computer system communicatively coupled to the task database and each AGV control circuit, the central computer system configured to:
determine that the capabilities of the plurality of AGVs and the length of the plurality of AGVs in the second orientation satisfies the transfer specification; and
instruct each AGV control circuit to move the AGV to the location coordinates at the time for transfer of the merchandise item;
wherein each AGV control circuit is configured to:
cause the AGV to move to the location coordinates at the time for transfer of the merchandise item;
arrange the AGV in a sequential order within the chain of AGVs in the second orientation;
cause the AGV to orient its conveyor assembly at a predetermined height and inclination;
cause the AGV to receive the merchandise item on its conveyor assembly from an upstream AGV in the chain when the AGV is not at the initial starting position; and
cause the AGV to transfer the merchandise item on its conveyor assembly to a downstream AGV in the chain when the AGV is not at the final transfer position.

2. The system of claim 1, wherein the transfer specification is a numeric string with separate numeric values in the string identifying location coordinates for the transfer of the merchandise item; start time, stop time, and duration for the transfer of the merchandise item; capabilities required for the plurality of AGVs; and the required length of the plurality of AGVs in the second orientation.

3. The system of claim 2, wherein the location coordinates represent specific unique position coordinates for each AGV to define a specific predetermined arrangement of the AGVs in the second orientation.

4. The system of claim 3, wherein each AGV control circuit is configured to:
move the AGV to its unique position in the predetermined arrangement of the AGVs;
and communicate with the central computer system to confirm when the AGV is in its unique position.

5. The system of claim 1 wherein
a first AGV control circuit is configured to move a first AGV to a first position in the delivery chain and to announce its position to the other AGV control circuits; and
a second AGV control circuit is configured to use a second AGV's one or more sensors to move the second AGV to a second position adjacent the first AGV.

6. The system of claim 1, wherein the capabilities required for the plurality of AGVs comprise one or more of: whether rollers are required for movement of the merchandise item, the required weight capacity of the AGVs to transfer the merchandise item, and whether a scanner is required to read and identify the merchandise item.

7. The system of claim 2, wherein the numeric string includes additional numeric values representing each AGV's predetermined position within the delivery chain and representing the angle of inclination of a first conveyor assembly at the initial starting position and the angle of inclination of a second conveyor assembly at the final transfer position.

8. The system of claim 1, wherein:
each AGV control circuit is configured to communicate the capabilities of the AGV to the central computer system;
the central computer system is configured to access the task database to determine the capabilities required in the transfer specification; and
the central computer system is configured to select the plurality of AGVs to perform the transfer if the capabilities of each AGV satisfies the capabilities required in the transfer specification.

9. The system of claim 1, wherein each AGV further comprises a hydraulic piston operatively coupled to the AGV control circuit and the AGV conveyor assembly, the hydraulic piston configured to allow adjustment of the height or inclination of the AGV conveyor assembly.

10. The system of claim 1, wherein the initial starting location is one of a delivery vehicle or a product bin and the final transfer location is the other of the delivery vehicle or the product bin.

11. A method for the loading and unloading of merchandise using a plurality of autonomous ground vehicles, the method comprising:
providing a plurality of autonomous ground vehicles (AGVs) for transferring a merchandise item, each AGV comprising:
a motorized locomotion system configured to facilitate movement of the AGV;
a navigational system for guiding the movement of the AGV;
one or more sensors for determining the AGV's position relative to other objects;
a conveyor assembly for the movement of the merchandise item from one AGV to another AGV;
a transceiver configured for wireless communication;
an AGV control circuit operatively coupled to the motorized locomotion system, the navigational system, the one or more sensors, the conveyor assembly, and the transceiver, the control circuit configured to operate and move the AGV;
forming a first, disassembled orientation of the plurality of AGVs in which at least one of the plurality of AGVs is not linked to another AGV;
forming a second, assembled orientation of the plurality of AGVs in which the AGVs are linked to one another to define a chain of AGVs extending from an initial starting position for the merchandise item to a final transfer position for the merchandise item;
providing a task database containing a transfer specification for the plurality of AGVs, the transfer specification comprising location coordinates for the transfer of the merchandise item, time for the transfer of the merchandise item, capabilities required for the plurality of AGVs, and the required length of the plurality of AGVs in the second orientation;
by a central computer system:
determining that the capabilities of the plurality of AGVs and the length of the plurality of AGVs in the second orientation satisfies the transfer specification; and
instructing each AGV control circuit to move the AGV to the location coordinates at the time for transfer of the merchandise item;
by each control circuit:
causing the AGV to move to the location coordinates at the time for transfer of the merchandise item;
arranging the AGV in a sequential order within the chain of AGVs in the second orientation;
causing the AGV to orient its conveyor assembly at a predetermined height and inclination;
causing the AGV to receive the merchandise item on its conveyor assembly from an upstream AGV in the chain when the AGV is not at the initial starting position; and
causing the AGV to transfer the merchandise item on its conveyor assembly to a downstream AGV in the chain when the AGV is not at the final transfer position.

12. The method of claim 11, wherein the transfer specification is a numeric string with separate numeric values in the string identifying location coordinates for the transfer of the merchandise item; start time, stop time, and duration for the transfer of the merchandise item; capabilities required for the plurality of AGVs; and the required length of the plurality of AGVs in the second orientation.

13. The method of claim 12, wherein the location coordinates represent specific unique position coordinates for each AGV to define a specific predetermined arrangement of the AGVs in the second orientation.

14. The method of claim 13, further comprising, by each AGV control circuit:
moving the AGV to its unique position in the predetermined arrangement of the AGVs;
and communicating with the central computer system to confirm when the AGV is in its unique position.

15. The method of claim 11 wherein
by a first AGV control circuit, moving a first AGV to a first position in the delivery chain and announcing its position to the other AGV control circuits; and
by a second AGV control circuit, using a second AGV's one or more sensors to move the second AGV to a second position adjacent the first AGV.

16. The method of claim 11, wherein the capabilities required for the plurality of AGVs comprise one or more of: whether rollers are required for movement of the merchandise item, the required weight capacity of the AGVs to transfer the merchandise item, and whether a scanner is required to read and identify the merchandise item.

17. The method of claim 12, wherein the numeric string includes additional numeric values representing each AGV's predetermined, position within the delivery chain and representing the angle of inclination of a first conveyor assembly at the initial starting position and the angle of inclination of a second conveyor assembly at the final transfer position.

18. The method of claim 11, wherein:
by each AGV control circuit, communicating the capabilities of the AGV to the central computer system;
by the central computer system, accessing the task database to determine the capabilities required in the transfer specification; and
by the central computer system, selecting the plurality of AGVs to perform the transfer if the capabilities of each AGV satisfies the capabilities required in the transfer specification.

19. The method of claim 11, wherein each AGV further comprises a hydraulic piston operatively coupled to the AGV control circuit and the AGV conveyor assembly, the hydraulic piston configured to allow adjustment of the inclination of the AGV conveyor assembly.

20. The method of claim 11, wherein the initial starting location is one of a delivery vehicle or a product bin and the final transfer location is the other of the delivery vehicle or the product bin.
